(19) United States
(12) Patent Application Publication
(10) Pub. No.: US 2022/0204693 A1
(43) Pub. Date: Jun. 30, 2022

(54) Polyamide-Imide Copolymer and Film Containing the Same

(71) Applicant: MICROCOSM TECHNOLOGY CO., LTD., Tainan City (TW)

(72) Inventors: Bo-Hung Lai, Tainan City (TW); Tang-Chieh Huang, Tainan City (TW)

(73) Assignee: MICROCOSM TECHNOLOGY CO., LTD., Tainan City (TW)

(21) Appl. No.: 17/404,606

(22) Filed: Aug. 17, 2021

(30) Foreign Application Priority Data
Dec. 25, 2020 (TW) 109146318

(51) Int. Cl. C08G 73/10; C08J 5/18

(52) U.S. Cl. CPC C08G 73/1007; C08J 2379/08; C08J 5/18

(57) ABSTRACT

The present invention provides a polyamide-imide copolymer, which is obtained by copolymerizing an aromatic diamine monomer, a dianhydride monomer and an aromatic dicarbonyl monomer, wherein the aromatic diamine monomer comprises a diamine containing an amide group (—CONH₂) represented by formula (1), and Q¹, X¹, X², R¹, R², Y¹, Y² and m are as defined herein:

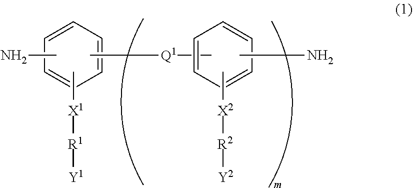

### BACKGROUND OF THE INVENTION

This application claims priority under 35 U.S.C. § 119 to Taiwanese Patent Application No. 109146318, filed Dec. 25, 2020, the entirety of which is incorporated by reference herein.

### FIELD OF THE INVENTION

The present invention relates to a transparent and colorless polyamide-imide copolymer with high rigidity (elastic modulus>5 GPa), good chemical resistance and low thermal expansion coefficient and a film thereof. The present invention also relates to an electronic device material, a TFT substrate, a transparent electrode substrate and a flexible display substrates using the film.

### DESCRIPTION OF THE PRIOR ART

With the development of displays, thinning, lightweight, and even flexibility have become the current direction of display development. Therefore, how to make glass substrates thinner and lighter, and even replace glass substrates with plastic substrates is a problem that the industry is thinking about.

Polyimide polymer is a kind of plastic material with thermal stability, high mechanical strength and chemical resistance. However, due to molecular structure, it is easy to cause charge transfer between molecules and within molecules, resulting in the yellow appearance of polyimide, which limits its application. In order to reduce the phenomenon of charge transfer, generally, linkage groups can be introduced to make the main chain flexible, or some larger groups can be introduced to destroy the stacking situation, and the effect can also be achieved. Common groups are, for example, (—O—), (—CO—), (—CH₂—), (—C(CF₃)₂—), etc.

In addition, it has also been proposed to use a highly transparent semi-alicyclic polyimide formed by combining an alicyclic tetracarboxylic dianhydride that does not cause charge transfer with an aromatic diamine. Such a semi-alicyclic polyimide has both transparency and bending properties. However, the polyimide resin produced according to the above proposal is difficult to exhibit sufficient heat resistance due to the curved structure or aliphatic ring compound, and the film produced using the polyimide resin still has the problems of poor mechanical properties and insufficient rigidity.

In recent years, in order to improve the rigidity and scratch resistance of polyimide, a polyamide-imide copolymer incorporating a polyamide unit structure has been developed. However, when the polyamide unit structure is introduced into the polyimide, the scratch resistance is improved, but there are limitations in solvent resistance. In particular, atomization will easily occur during coating of the photoresist ink or scratch-resistant hard coat paint in the subsequent process.

### SUMMARY OF THE INVENTION

In view of the above technical problems, an object of the present invention is to provide a film suitable for use in substrates for flexible displays or solar cells. The film has transparency, high rigidity, good chemical resistance and low linear thermal expansion coefficient.

To achieve the above object, the present invention provides a polyamide-imide copolymer obtained by copolymerizing an aromatic diamine monomer, a dianhydride monomer and an aromatic dicarbonyl monomer, wherein a molar number of the aromatic dicarbonyl monomer accounts for 40%-60% of a total molar number of the dianhydride monomer and the aromatic dicarbonyl monomer; and the aromatic diamine monomer comprises a diamine containing an amide group (—CONH₂), the diamine containing the amide group is represented by formula (1) below, and the diamine containing the amide group (—CONH₂) accounts for 5-20% of a total molar number of the aromatic diamine monomer:

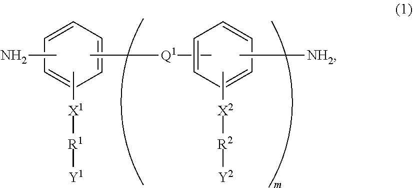

wherein m is an integer from 0 to 5; Q¹ is the same or different each time it appears and each independently —CH₂—, —C₂H₄—, —C₂H₂—, —C₃H₆—, —C₃H₄—, —C₄H₈—, —C₄H₆—, —C₄H₄—, —C(CF₃)₂—, —O—, —CONH—, —NHCO—, —COO—, —OCO—, —NH—, —CO—, —SO₂—, —SO₂NH— or —NHSO₂—; X^{x} and X² are the same or different, X² is the same or different each time it appears, X¹ and are each independently a single bond, —CONH—, —NHCO—, —CONHCH₂—, —CH₂CONH—, —CH₂NHCO—, —NHCOCH₂—, —COO—, —OCO—, —COOCH₂—, —CH₂COO—, —CH₂OCO—, —OCOCH₂—, —CO—, —CH₂CO—, —COCH₂—, —CH₂SO₂NH—, —SO₂NHCH₂—, —NHSO₂CH₂— or —CH₂NHSO₂—; R¹ and R² are the same or different, R² is the same or different each time it appears, R¹ and R² are each independently a single bond, C₁-C₃₀ alkylene, C₁-C₃₀ divalent carbocyclic or C₁-C₃₀ divalent heterocyclic ring, the alkylene, the divalent carbocyclic and the divalent heterocyclic ring may be substituted by one or more fluorine or organic groups; Y¹ and Y² are the same or different, Y² is the same or different each time it appears, Y¹ and Y² are each independently a hydrogen atom or —CONH₂, provided that at least one of Y¹ and Y² is —CONH₂.

Preferably, the aromatic diamine monomer further comprises 2-(trifluoromethyl)-1,4-phenylenediamine, bis(trifluoromethyl)benzidine (TFDB), 4,4′-oxydianiline (ODA), para-Methylene Dianiline (pMDA), meta-Methylene Dianiline (mMDA), 1,3-bis(3-aminophenoxy)benzene (133APB), 1,3-bis(4-aminophenoxy)benzene (134APB), 2,2′-bis[4(4-aminophenoxy)phenyl]hexafluoropropane (4BDAF), 2,2′-bis(3-aminophenyl)hexafluoropropane (33-6F), (2,2′-bis(4-aminophenyl)hexafluoropropane (44-6F), bis(4-aminophenyl)sulfone (4DDS), bis(3-aminophenyl)sulfone (3DDS), 2,2-Bis[4-(4-aminophenoxy)-phenyl]propane (6HMDA), 2,2-Bis(3-amino-4-hydroxy-phenyl)-hexafluoropropane (DBOH), 4,4′-Bis(3-amino phenoxy)diphenyl sulfone (DBSDA), 9,9-Bis(4-aminophenyl)fluorene (FDA), 9,9-Bis(3-fluoro-4-aminophenyl)fluorene (FFDA), polyetheramine or a combination thereof.

Preferably, the diamine containing the amide group comprises

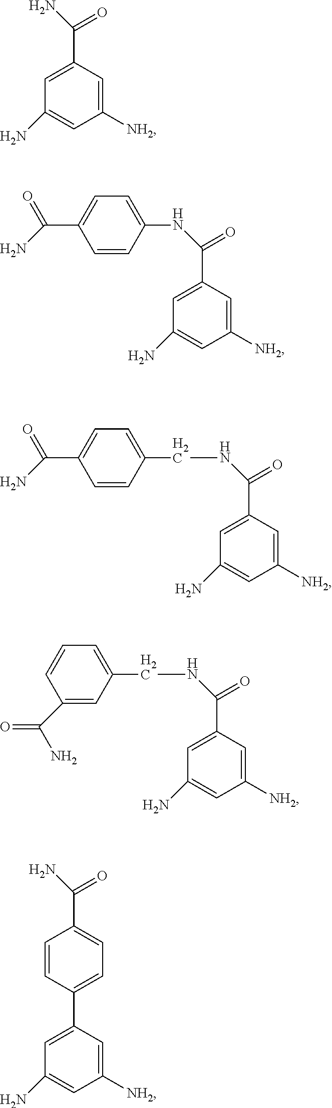 [SMILES: NC(=O)c1cc(N)cc(N)c1 ; NC(=O)c1ccc(NC(=O)c2cc(N)cc(N)c2)cc1 ; NC(=O)c1ccc(CNC(=O)c2cc(N)cc(N)c2)cc1 ; NC(=O)c1cccc(CNC(=O)c2cc(N)cc(N)c2)c1 ; NC(=O)c1ccc(-c2cc(N)cc(N)c2)cc1]

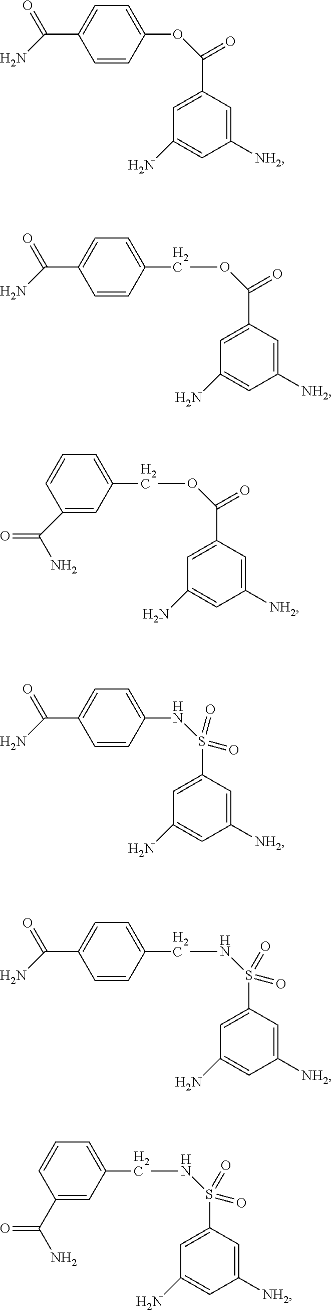 [SMILES: NC(=O)c1ccc(OC(=O)c2cc(N)cc(N)c2)cc1 ; NC(=O)c1ccc(COC(=O)c2cc(N)cc(N)c2)cc1 ; NC(=O)c1cccc(COC(=O)c2cc(N)cc(N)c2)c1 ; NC(=O)c1ccc(NS(=O)(=O)c2cc(N)cc(N)c2)cc1 ; NC(=O)c1ccc(CNS(=O)(=O)c2cc(N)cc(N)c2)cc1 ; NC(=O)c1cccc(CNS(=O)(=O)c2cc(N)cc(N)c2)c1]

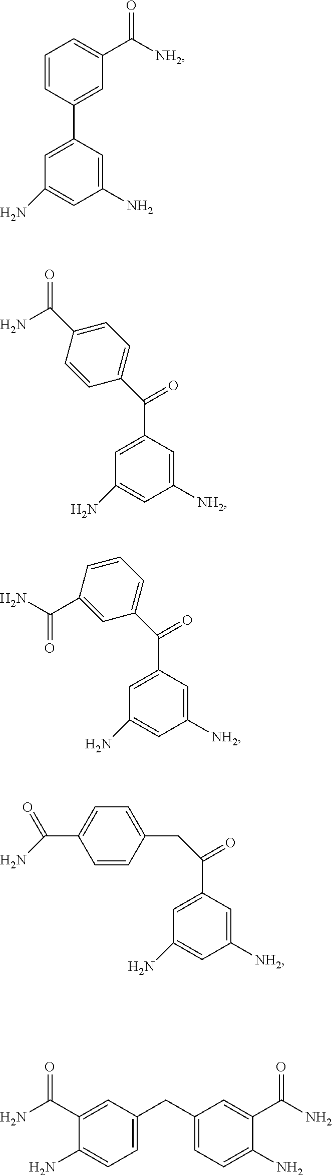 [SMILES: NC(=O)c1cccc(-c2cc(N)cc(N)c2)c1 ; NC(=O)c1ccc(C(=O)c2cc(N)cc(N)c2)cc1 ; NC(=O)c1cccc(C(=O)c2cc(N)cc(N)c2)c1 ; NC(=O)c1ccc(CC(=O)c2cc(N)cc(N)c2)cc1 ; NC(=O)c1cc(Cc2ccc(N)c(C(N)=O)c2)ccc1N]

or a combination thereof.

Preferably, the dianhydride monomer comprises an aromatic dianhydride, an aliphatic dianhydride or a combination thereof.

Preferably, the aromatic dianhydride comprises 4,4′-(4,4′-isopropyldienediphenoxy)bis(phthalic anhydride), 4,4′-(hexafluoroisopropylene)diphthalic anhydride, 3,3′,4,4′-benzophenonetetracarboxylic dianhydride, 3,3′,4,4′-biphenyl tetracarboxylic dianhydride, 2,3,3′,4′-biphenyl tetracarboxylic dianhydride, 4,4′-oxydiphthalic anhydride, 3,3′,4,4′-diphenylsulfonetetracarboxylic dianhydride, biscarboxyphenyl dimethyl silane dianhydride, bis-dicarboxyphenoxydiphenyl sulfide dianhydride, sulfonyl diphthalic anhydride or a combination thereof.

Preferably, the aliphatic dianhydride comprises 1,2,3,4-cyclobutanetetracarboxylic dianhydride, cyclohexane-1,2,4,5-tetracarboxylic dianhydride, 1,1′-bi(cyclohexyl)-3,3′,4,4′-tetracarboxylic dianhydride, 1,1′-bi(cyclohexane)-2,3,3′,4′-tetracarboxylic dianhydride, 1,1′-bi(cyclohexane)-2,2′,3,3′-tetracarboxylic dianhydride, 4,4′-methylene bis(cyclohexane-1,2-dicarboxylic anhydride), 4,4′-(propane-2,2-diyl)bis(cyclohexane-1,2-dicarboxylic anhydride), 4,4′-oxybis(cyclohexane-1,2-dicarboxylic anhydride), 4,4′-thiobis(cyclohexane-1,2-dicarboxylic anhydride), 4,4′-sulfonyl bis(cyclohexane-1,2-dicarboxylic anhydride), 4,4′-(dimethylsilanediyl) bis(cyclohexane-1,2-dicarboxylic anhydride), 4,4′-(tetrafluoropropane-2,2-diyl) bis(cyclohexane-1,2-dicarboxylic anhydride), octahydro-pentalene-1,3,4,6-tetracarboxylic dianhydride, bicyclo[2.2.1]heptane-2,3,5,6-tetracarboxylic dianhydride, (8aS)-hexahydro-3H-4,9-Methylfuran[3,4-g]isopentene-1,3,5,7(3aH)-tetraketone, bicyclo[2.2.2]octane-2,3,5,6-tetracarboxylic dianhydride, bicyclo[2.2.2]oct-5-ene-2,3,7,8-tetracarboxylic dianhydride, tricyclo[4.2.2.02,5]decane-3,4,7,8-tetracarboxylic dianhydride, tricyclo[4.2.2.02,5]dec-7-ene-3,4,9,10-tetracarboxylic dianhydride, 9-oxatricyclo[4.2.1.02,5]nonane-3,4,7,8-tetracarboxylic dianhydride, norbornane-2-spiro-α-cyclopentanone-α′spiro-2′-norbornane-5,5′,6,6′-tetracarboxylic dianhydride, (4arH,8acH)-decahydro-1t,4t:5c,8c-dimethanonaphthalene-2c,3c,6c,7c-tetracarboxylic dianhydride, (4arH,8acH)-decahydro-1t,4t:5c,8c-dimethanonaphthalene-2t,3t,6c,7c-tetracarboxylic dianhydride or a combination thereof.

Preferably, the aromatic dicarbonyl monomer includes 4,4′-biphenyldicarbonyl chloride (BPC), isophthaloyl chloride (IPC), terephthaloyl chloride (TPC) or a combination thereof.

Preferably, the aromatic diamine monomer excludes the aromatic diamine substituted by the nitrile group.

The present invention also provides a film, which comprises the copolymer described above.

Preferably, the film has an elastic modulus of greater than 5 GPa.

According to the present invention, a polyamide-imide film with transparency, high rigidity, good chemical resistance and low linear thermal expansion coefficient can be obtained.

### DETAILED DESCRIPTION OF THE EMBODIMENTS

The polyamide-imide copolymer provided in the present invention is obtained by copolymerizing an aromatic diamine monomer, a dianhydride monomer and an aromatic dicarbonyl monomer, wherein a molar number of the aromatic dicarbonyl monomer accounts for 40%-60% of a total molar number of the dianhydride monomer and the aromatic dicarbonyl monomer; and the aromatic diamine monomer comprises a diamine containing an amide group (—CONH₂), the diamine containing the amide group is represented by formula (1) below, and the diamine containing the amide group (—CONH₂) accounts for 5-20% of a total molar number of the aromatic diamine monomer:

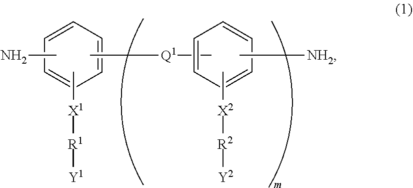

wherein m is an integer from 0 to 5 (such as 1, 2, 3 or 4); Q¹ is the same or different each time it appears (i.e., when there are multiple Q¹s, the Q¹s can be the same or different from each other) and each independently —CH₂—, —C₂H₄—, —C₂H₂—, —C₃H₆—, —C₃H₄—, —C₄H₈—, —C₄H₆—, —C₄H₄—, —C(CF₃)₂—, —O—, —CONH—, —NHCO—, —COO—, —OCO—, —NH—, —CO—, —SO₂—, —SO₂NH— or —NHSO₂—; X¹ and X² are the same or different, X² is the same or different each time it appears (i.e., when there are multiple X²s, the X²s can be the same or different from each other), X¹ and X² are each independently a single bond, —CONH—, —NHCO—, —CONHCH₂—, —CH₂CONH—, —CH₂NHCO—, —NHCOCH₂—, —COO—, —OCO—, —COOCH₂—, —CH₂COO—, —CH₂OCO—, —OCOCH₂—, —CO—, —CH₂CO—, —COCH₂—, —CH₂SO₂NH—, —SO₂NHCH₂—, —NHSO₂CH₂— or —CH₂NHSO₂—; R¹ and R² are the same or different, R² is the same or different each time it appears (i.e., when there are multiple R²s, the R²s can be the same or different from each other), R¹ and R² are each independently a single bond, C₁-C₃₀ alkylene, C₁-C₃₀ divalent carbocyclic or C₁-C₃₀ divalent heterocyclic ring, the alkylene, the divalent carbocyclic and the divalent heterocyclic ring may be substituted by one or more fluorine or organic groups; Y¹ and Y² are the same or different, Y² is the same or different each time it appears (i.e., when there are multiple Y²s, the Y²s can be the same or different from each other), Y¹ and Y² are each independently a hydrogen atom or —CONH₂, provided that at least one of Y¹ and Y² is —CONH₂.

The aromatic diamine monomer may comprise other aromatic diamine monomer, which includes, but is not limited to, 2-(trifluoromethyl)-1,4-phenylenediamine, bis(trifluoromethyl)benzidine (TFDB), 4,4′-oxydianiline (ODA), para-Methylene Dianiline (pMDA), meta-Methylene Dianiline (mMDA), 1,3-bis(3-aminophenoxy)benzene (133APB), 1,3-bis(4-aminophenoxy)benzene (134APB), 2,2′-bis[4(4-aminophenoxy)phenyl]hexafluoropropane (4BDAF), 2,2′-bis(3-aminophenyl)hexafluoropropane (33-6F), (2,2′-bis(4-aminophenyl)hexafluoropropane (44-6F), bis(4-aminophenyl)sulfone (4DDS), bis(3-aminophenyl)sulfone (3DDS), 2,2-Bis[4-(4-aminophenoxy)-phenyl]propane (6HMDA), 2,2-Bis(3-amino-4-hydroxy-phenyl)-hexafluoropropane (DBOH), 4,4′-Bis(3-amino phenoxy)diphenyl sulfone (DBSDA), 9,9-Bis(4-aminophenyl)fluorene (FDA), 9,9-Bis(3-fluoro-4-aminophenyl)fluorene (FFDA), polyetheramine or a combination of two or more (such as: three or more) of the foregoing. Examples of the polyetheramine include but are not limited to: JEFFAMINE® M600, M1000, D400, D2000, ED600, and ED900.

In the present invention, the diamine containing the amide group represented by formula (1) can be used alone or in a combination of two or more. Specific examples of the diamine containing the amide group represented by formula (1) include but are not limited to:

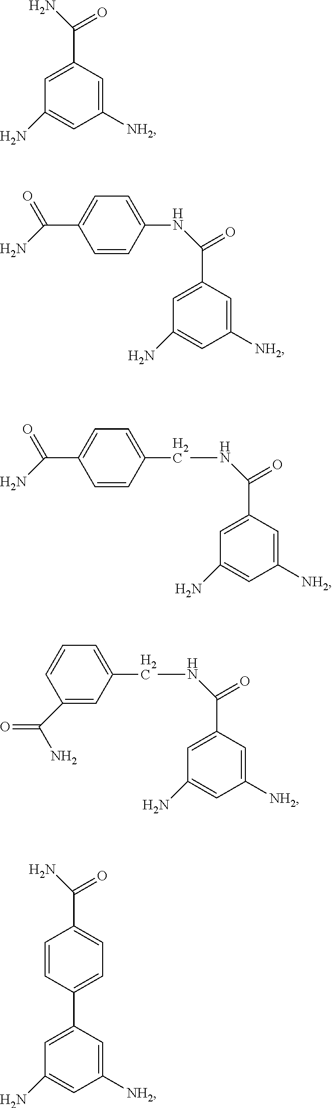 [SMILES: NC(=O)c1cc(N)cc(N)c1 ; NC(=O)c1ccc(NC(=O)c2cc(N)cc(N)c2)cc1 ; NC(=O)c1ccc(CNC(=O)c2cc(N)cc(N)c2)cc1 ; NC(=O)c1cccc(CNC(=O)c2cc(N)cc(N)c2)c1 ; NC(=O)c1ccc(-c2cc(N)cc(N)c2)cc1]

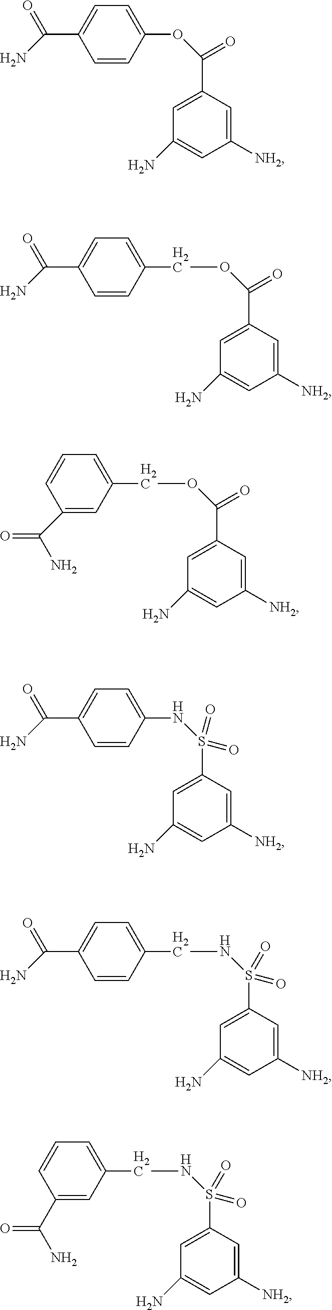 [SMILES: NC(=O)c1ccc(OC(=O)c2cc(N)cc(N)c2)cc1 ; NC(=O)c1ccc(COC(=O)c2cc(N)cc(N)c2)cc1 ; NC(=O)c1cccc(COC(=O)c2cc(N)cc(N)c2)c1 ; NC(=O)c1ccc(NS(=O)(=O)c2cc(N)cc(N)c2)cc1 ; NC(=O)c1ccc(CNS(=O)(=O)c2cc(N)cc(N)c2)cc1 ; NC(=O)c1cccc(CNS(=O)(=O)c2cc(N)cc(N)c2)c1]

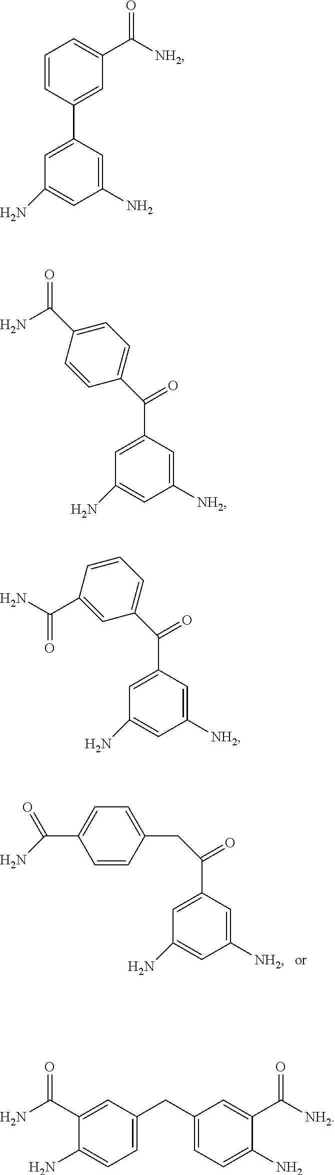 [SMILES: NC(=O)c1cccc(-c2cc(N)cc(N)c2)c1 ; NC(=O)c1ccc(C(=O)c2cc(N)cc(N)c2)cc1 ; NC(=O)c1cccc(C(=O)c2cc(N)cc(N)c2)c1 ; NC(=O)c1ccc(CC(=O)c2cc(N)cc(N)c2)cc1 ; NC(=O)c1cc(Cc2ccc(N)c(C(N)=O)c2)ccc1N]

In a preferred embodiment, the aromatic diamine monomer does not contain a silicon atom and/or does not contain an aromatic diamine substituted with a nitrile group.

The dianhydride monomer can be aromatic dianhydride, aliphatic dianhydride or a combination thereof. Examples of the aromatic dianhydride include but are not limited to: 4,4′-(4,4′-isopropyldienediphenoxy)bis(phthalic anhydride), 4,4′-(hexafluoroisopropylene)diphthalic anhydride, 3,3′,4,4′-benzophenonetetracarboxylic dianhydride, 3,3′,4,4′-biphenyl tetracarboxylic dianhydride, 2,3,3′,4′-biphenyl tetracarboxylic dianhydride, 4,4′-oxydiphthalic anhydride, 3,3′,4,4′-diphenylsulfonetetracarboxylic dianhydride, biscarboxyphenyl dimethyl silane dianhydride, bis-dicarboxyphenoxydiphenyl sulfide dianhydride or sulfonyl diphthalic anhydride. The aromatic dianhydride can be used alone or in a combination of two or more. The aliphatic dianhydride comprises, but is not limited to, 1,2,3,4-cyclobutanetetracarboxylic dianhydride, cyclohexane-1,2,4,5-tetracarboxylic dianhydride, 1,1′-bi(cyclohexyl)-3,3′,4,4′-tetracarboxylic dianhydride, 1,1′-bi(cyclohexane)-2,3,3′,4′-tetracarboxylic dianhydride, 1,1′-bi(cyclohexane)-2,2′,3,3′-tetracarboxylic dianhydride, 4,4′-methylene bis(cyclohexane-1,2-dicarboxylic anhydride), 4,4′-(propane-2,2-diyl)bis(cyclohexane-1,2-dicarboxylic anhydride), 4,4′-oxybis(cyclohexane-1,2-dicarboxylic anhydride), 4,4′-thiobis(cyclohexane-1,2-dicarboxylic anhydride), 4,4′-sulfonyl bis(cyclohexane-1,2-dicarboxylic anhydride), 4,4′-(dimethylsilanediyl) bis(cyclohexane-1,2-dicarboxylic anhydride), 4,4′-(tetrafluoropropane-2,2-diyl) bis(cyclohexane-1,2-dicarboxylic anhydride), octahydro-pentalene-1,3,4,6-tetracarboxylic dianhydride, bicyclo[2.2.1]heptane-2,3,5,6-tetracarboxylic dianhydride, (8aS)-hexahydro-3H-4,9-Methylfuran[3,4-g]isopentene-1,3,5,7(3aH)-tetraketone, bicyclo[2.2.2]octane-2,3,5,6-tetracarboxylic dianhydride, bicyclo[2.2.2]oct-5-ene-2,3,7,8-tetracarboxylic dianhydride, tricyclo[4.2.2.02,5]decane-3,4,7,8-tetracarboxylic dianhydride, tricyclo[4.2.2.02,5]dec-7-ene-3,4,9,10-tetracarboxylic dianhydride, 9-oxatricyclo[4.2.1.02,5]nonane-3,4,7,8-tetracarboxylic dianhydride, norbornane-2-spiro-α-cyclopentanone-α′spiro-2′-norbornane-5,5′,6,6′-tetracarboxylic dianhydride, (4arH,8acH)-decahydro-1t,4t:5c,8c-dimethanonaphthalene-2c,3c,6c,7c-tetracarboxylic dianhydride or (4arH,8acH)-decahydro-1t,4t:5c,8c-dimethanonaphthalene-2t,3t,6c,7c-tetracarboxylic dianhydride. The aliphatic dianhydride can be used alone or in a combination of two or more.

In the present invention, the aromatic dicarbonyl monomer can be used alone or in combination of two or more. The aromatic dicarbonyl monomer may be 4,4′-biphenyldicarbonyl chloride, isophthaloyl chloride or terephthaloyl chloride.

In a preferred embodiment, the polyamide-imide copolymer is the imidization product of polyamic acid and obtained by copolymerization of the aromatic diamine monomer, the aromatic dianhydride monomer and the aromatic dicarbonyl monomer. The polyamic acid can be a block copolymer or a random copolymer; the polyamide-imide copolymer can also be a block copolymer or a random copolymer.

In a preferred embodiment, the polyamide-imide copolymer is obtained by copolymerization of at least two aromatic diamine monomers, at least two aromatic dianhydride monomers and at least one aromatic dicarbonyl monomer. In another preferred embodiment, the polyamide-imide copolymer is obtained by copolymerization of at least three aromatic diamine monomers, at least two aromatic dianhydride monomers and at least one aromatic dicarbonyl monomer.

The polymerization conditions for preparing polyamic acid are not particularly limited. The polymerization of polyamic acid can preferably be carried out by solution polymerization at 1° C. to 100° C. in an inert environment. Examples of suitable solvents for polymerizing polyamic acid include N,N-dimethylformamide, dimethylacetamide, dimethylsulfone, acetone, N-methyl-2-pyrrolidone, tetrahydrofuran, chloroform or γ-butyrolactone, but are not limited thereto.

The imidization of polyamic acid can be performed thermally or chemically. For example, the polyamic acid can be chemically polyimidized by compounds such as acetic anhydride or pyridine.

The present invention also provides a film, which comprises the polyamide-imide copolymer. In a preferred embodiment, the film is made by the polyamide-imide copolymer.

In a preferred embodiment, the film is obtained by dissolving the polyamide-imide copolymer in a solvent to obtain a polyamide-imide solution; then, filtering the solution to obtain a filtered solution; then coating the filtered solution on a substrate to obtain a coated substrate; and baking the coated substrate. The coating method is not particularly limited and can be drop coating, blade coating, spin coating, dip coating or slot die coating. The baking temperature can be 230˜400° C., for example, 250˜350° C., 275˜325° C. or 290˜310° C. The thickness of the film is preferably between 5 μm and 50 μm, for example, 10 μm, 20 μm, 30 μm or 40 μm.

In a preferred embodiment, the linear thermal expansion coefficient (CTE) of the film can be reduced by more than 30%, for example, more than 40%, 50%, 60%, 70%, 80% or 90%, in the range of 50° C. to 200° C.

In a preferred embodiment, the YI (yellowness index) of the film is lower than 3, for example, lower than 2.5, 2.2, 2 or 1.8. In another preferred embodiment, the elastic modulus of the film is greater than 5 GPa, for example, greater than 5.3, 5.7, 6.0, 6.3 or 6.5.

In a preferred embodiment, the total light transmittance of the film is over 89%. In another preferred embodiment, the haze of the film is less than 1%, and the haze variation is less than 5%.

In order to highlight the efficacy of the present invention, the inventors completed the Examples and Comparative Examples in the manner set out below. The following Examples and Comparative Examples will further illustrate the present invention. However, these Examples and Comparative Examples are not intended to limit the scope of the present invention. Any changes and modifications made by people having ordinary skill in the art of the present invention without departing from the spirit of the present invention will fall within the scope of the present invention.

Monomers used in the examples:
2,2′-bis(trifluoromethyl)benzidine (TFMB)

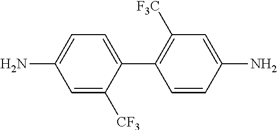 [SMILES: Nc1ccc(-c2ccc(N)cc2C(F)(F)F)c(C(F)(F)F)c1]

2-(trifluoromethyl)-1,4-phenylenediamine

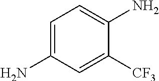 [SMILES: Nc1ccc(N)c(C(F)(F)F)c1]

3,5-diaminobenzamide (3,5-DABAM)

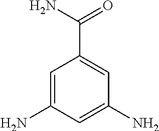 [SMILES: NC(=O)c1cc(N)cc(N)c1]

5,5′-methylenebis(2-aminobenzamide)

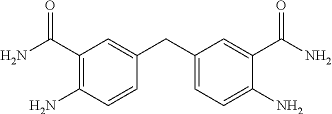 [SMILES: NC(=O)c1cc(Cc2ccc(N)c(C(N)=O)c2)ccc1N]

2,2-bis(3,4-dicarboxyphenyl)hexafluoropropane (6FDA)

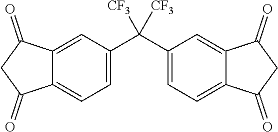 [SMILES: O=C1CC(=O)c2cc(C(c3ccc4c(c3)C(=O)CC4=O)(C(F)(F)F)C(F)(F)F)ccc21]

Cyclobutane-1,2,3,4-tetracarboxylic dianhydride (CBDA)

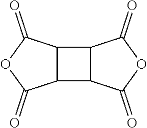 [SMILES: O=C1OC(=O)C2C1C1C(=O)OC(=O)C21]

3,3′,4,4′-biphenyl tetracarboxylic dianhydride (s-BPDA)

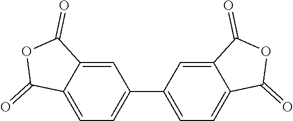 [SMILES: O=C1OC(=O)c2cc(-c3ccc4c(c3)C(=O)OC4=O)ccc21]

4,4′-oxydiphthalic anhydride (ODPA)

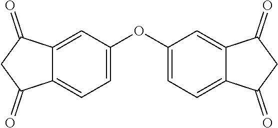 [SMILES: O=C1CC(=O)c2cc(Oc3ccc4c(c3)C(=O)CC4=O)ccc21]

Isophthaloyl Chloride (IPC)

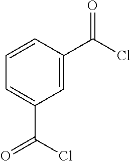 [SMILES: O=C(Cl)c1cccc(C(=O)Cl)c1]

Terephthaloyl Chloride (TPC)

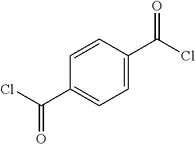 [SMILES: O=C(Cl)c1ccc(C(=O)Cl)cc1]

### Example 1

9 mmol of 2,2′-bis(trifluoromethyl)benzidine (TFMB) and 1 mmol of 3,5-diaminobenzamide were added into the reaction vessel and dissolved in dimethylacetamide with stirring in nitrogen atmosphere. The amount of solvent was equivalent to 15% by weight of the total solid weight content. After it was completely dissolved, 2 mmol of CBDA and 3 mmol of 6FDA were added and stirred for 4 hours for dissolution and reaction, and the temperature of the solution was maintained at 15° C. Afterwards, 5 mmol of TPC was added and stirred for another 12 hours to continue the reaction. Then, 15 mmol of pyridine and 30 mmol of acetic anhydride were added and stirred for 30 minutes, followed by heating to 70° C. and stirring for 1 hour, and then cooling to room temperature. Finally, a large amount of methanol was used for precipitation, and then the precipitated solid was crushed by a pulverizer and dried into powder by vacuum drying.

### Example 2

9 mmol of 2,2′-bis(trifluoromethyl)benzidine (TFMB) and 1 mmol of 3,5-diaminobenzamide were added into the reaction vessel and dissolved in dimethylacetamide with stirring in nitrogen atmosphere. The amount of solvent was equivalent to 15% by weight of the total solid weight content. After it was completely dissolved, 2 mmol of s-BPDA and 3 mmol of 6FDA were added and stirred for 4 hours for dissolution and reaction, and the temperature of the solution was maintained at 15° C. Afterwards, 5 mmol of TPC was added and stirred for another 12 hours to continue the reaction. Then, 15 mmol of pyridine and 30 mmol of acetic anhydride were added and stirred for 30 minutes, followed by heating to 70° C. and stirring for 1 hour, and then cooling to room temperature. Finally, a large amount of methanol was used for precipitation, and then the precipitated solid was crushed by a pulverizer and dried into powder by vacuum drying.

### Example 3

9 mmol of 2,2′-bis(trifluoromethyl)benzidine (TFMB) and 1 mmol of 3,5-diaminobenzamide were added into the reaction vessel and dissolved in dimethylacetamide with stirring in nitrogen atmosphere. The amount of solvent was equivalent to 15% by weight of the total solid weight content. After it was completely dissolved, 2 mmol of ODPA and 3 mmol of 6FDA were added and stirred for 4 hours for dissolution and reaction, and the temperature of the solution was maintained at 15° C. Afterwards, 5 mmol of TPC was added and stirred for another 12 hours to continue the reaction. Then, 15 mmol of pyridine and 30 mmol of acetic anhydride were added and stirred for 30 minutes, followed by heating to 70° C. and stirring for 1 hour, and then cooling to room temperature. Finally, a large amount of methanol was used for precipitation, and then the precipitated solid was crushed by a pulverizer and dried into powder by vacuum drying.

### Example 4

9 mmol of 2,2′-bis(trifluoromethyl)benzidine (TFMB) and 1 mmol of 5,5′-methylenebis(2-aminobenzamide) were added into the reaction vessel and dissolved in dimethylacetamide with stirring in nitrogen atmosphere. The amount of solvent was equivalent to 15% by weight of the total solid weight content. After it was completely dissolved, 2 mmol of CBDA and 3 mmol of 6FDA were added and stirred for 4 hours for dissolution and reaction, and the temperature of the solution was maintained at 15° C. Afterwards, 5 mmol of TPC was added and stirred for another 12 hours to continue the reaction. Then, 15 mmol of pyridine and 30 mmol of acetic anhydride were added and stirred for 30 minutes, followed by heating to 70° C. and stirring for 1 hour, and then cooling to room temperature. Finally, a large amount of methanol was used for precipitation, and then the precipitated solid was crushed by a pulverizer and dried into powder by vacuum drying.

### Example 5

9.5 mmol of 2,2′-bis(trifluoromethyl)benzidine (TFMB) and 0.5 mmol of 3,5-diaminobenzamide were added into the reaction vessel and dissolved in dimethylacetamide with stirring in nitrogen atmosphere. The amount of solvent was equivalent to 15% by weight of the total solid weight content. After it was completely dissolved, 2 mmol of CBDA and 3 mmol of 6FDA were added and stirred for 4 hours for dissolution and reaction, and the temperature of the solution was maintained at 15° C. Afterwards, 5 mmol of TPC was added and stirred for another 12 hours to continue the reaction. Then, 15 mmol of pyridine and 30 mmol of acetic anhydride were added and stirred for 30 minutes, followed by heating to 70° C. and stirring for 1 hour, and then cooling to room temperature. Finally, a large amount of methanol was used for precipitation, and then the precipitated solid was crushed by a pulverizer and dried into powder by vacuum drying.

### Example 6

8 mmol of 2,2′-bis(trifluoromethyl)benzidine (TFMB) and 2 mmol of 3,5-diaminobenzamide were added into the reaction vessel and dissolved in dimethylacetamide with stirring in nitrogen atmosphere. The amount of solvent was equivalent to 15% by weight of the total solid weight content. After it was completely dissolved, 2 mmol of CBDA and 3 mmol of 6FDA were added and stirred for 4 hours for dissolution and reaction, and the temperature of the solution was maintained at 15° C. Afterwards, 5 mmol of TPC was added and stirred for another 12 hours to continue the reaction. Then, 15 mmol of pyridine and 30 mmole of acetic anhydride were added and stirred for 30 minutes, followed by heating to 70° C. and stirring for 1 hour, and then cooling to room temperature. Finally, a large amount of methanol was used for precipitation, and then the precipitated solid was crushed by a pulverizer and dried into powder by vacuum drying.

### Example 7

7 mmol of 2,2′-bis(trifluoromethyl)benzidine (TFMB), 2 mmol of 2-(trifluoromethyl)-1,4-phenylene diamine and 1 mmol of 3,5-diaminobenzamide were added into the reaction vessel and dissolved in dimethylacetamide with stirring in nitrogen atmosphere. The amount of solvent was equivalent to 15% by weight of the total solid weight content. After it was completely dissolved, 2 mmol of CBDA and 3 mmol of 6FDA were added and stirred for 4 hours for dissolution and reaction, and the temperature of the solution was maintained at 15° C. Afterwards, 5 mmol of TPC was added and stirred for another 12 hours to continue the reaction. Then, 15 mmol of pyridine and 30 mmol of acetic anhydride were added and stirred for 30 minutes, followed by heating to 70° C. and stirring for 1 hour, and then cooling to room temperature. Finally, a large amount of methanol was used for precipitation, and then the precipitated solid was crushed by a pulverizer and dried into powder by vacuum drying.

### Example 8

9.5 mmol of 2,2′-bis(trifluoromethyl)benzidine (TFMB) and 0.5 mmol of 3,5-diaminobenzamide were added into the reaction vessel and dissolved in dimethylacetamide with stirring in nitrogen atmosphere. The amount of solvent was equivalent to 15% by weight of the total solid weight content. After it was completely dissolved, 2 mmol of CBDA and 3 mmol of 6FDA were added and stirred for 4 hours for dissolution and reaction, and the temperature of the solution was maintained at 15° C. Afterwards, 5 mmol of IPC was added and stirred for another 12 hours to continue the reaction. Then, 15 mmol of pyridine and 30 mmol of acetic anhydride were added and stirred for 30 minutes, followed by heating to 70° C. and stirring for 1 hour, and then cooling to room temperature. Finally, a large amount of methanol was used for precipitation, and then the precipitated solid was crushed by a pulverizer and dried into powder by vacuum drying.

### Example 9

9.5 mmol of 2,2′-bis(trifluoromethyl)benzidine (TFMB) and 0.5 mmol of 3,5-diaminobenzamide were added into the reaction vessel and dissolved in dimethylacetamide with stirring in nitrogen atmosphere. The amount of solvent was equivalent to 15% by weight of the total solid weight content. After it was completely dissolved, 2 mmol of CBDA and 2 mmol of 6FDA were added and stirred for 4 hours for dissolution and reaction, and the temperature of the solution was maintained at 15° C. Afterwards, 6 mmol of TPC was added and stirred for another 12 hours to continue the reaction. Then, 15 mmol of pyridine and 30 mmol of acetic anhydride were added and stirred for 30 minutes, followed by heating to 70° C. and stirring for 1 hour, and then cooling to room temperature. Finally, a large amount of methanol was used for precipitation, and then the precipitated solid was crushed by a pulverizer and dried into powder by vacuum drying.

### Example 10

9.5 mmol of 2,2′-bis(trifluoromethyl)benzidine (TFMB) and 0.5 mmol of 3,5-diaminobenzamide were added into the reaction vessel and dissolved in dimethylacetamide with stirring in nitrogen atmosphere. The amount of solvent was equivalent to 15% by weight of the total solid weight content. After it was completely dissolved, 3 mmol of CBDA and 3 mmol of 6FDA were added and stirred for 4 hours for dissolution and reaction, and the temperature of the solution was maintained at 15° C. Afterwards, 4 mmol of TPC was added and stirred for another 12 hours to continue the reaction. Then, 15 mmol of pyridine and 30 mmol of acetic anhydride were added and stirred for 30 minutes, followed by heating to 70° C. and stirring for 1 hour, and then cooling to room temperature. Finally, a large amount of methanol was used for precipitation, and then the precipitated solid was crushed by a pulverizer and dried into powder by vacuum drying.

### Comparative Example 1

10 mmol of 2,2′-bis(trifluoromethyl)benzidine (TFMB) was added into the reaction vessel and dissolved in dimethylacetamide with stirring in nitrogen atmosphere. The amount of solvent was equivalent to 15% by weight of the total solid weight content. After it was completely dissolved, 2 mmol of CBDA and 3 mmol of 6FDA were added and stirred for 4 hours for dissolution and reaction, and the temperature of the solution was maintained at 15° C. Afterwards, 5 mmol of TPC was added and stirred for another 12 hours to continue the reaction. Then, 15 mmol of pyridine and 30 mmol of acetic anhydride were added and stirred for 30 minutes, followed by heating to 70° C. and stirring for 1 hour, and then cooling to room temperature. Finally, a large amount of methanol was used for precipitation, and then the precipitated solid was crushed by a pulverizer and dried into powder by vacuum drying.

### Comparative Example 2

9.9 mmol of 2,2′-bis(trifluoromethyl)benzidine (TFMB) and 0.1 mmol of 3,5-diaminobenzamide were added into the reaction vessel and dissolved in dimethylacetamide with stirring in nitrogen atmosphere. The amount of solvent was equivalent to 15% by weight of the total solid weight content. After it was completely dissolved, 2 mmol of CBDA and 3 mmol of 6FDA were added and stirred for 4 hours for dissolution and reaction, and the temperature of the solution was maintained at 15° C. Afterwards, 5 mmol of TPC was added and stirred for another 12 hours to continue the reaction. Then, 15 mmol of pyridine and 30 mmol of acetic anhydride were added and stirred for 30 minutes, followed by heating to 70° C. and stirring for 1 hour, and then cooling to room temperature. Finally, a large amount of methanol was used for precipitation, and then the precipitated solid was crushed by a pulverizer and dried into powder by vacuum drying.

### Comparative Example 3

7 mmol of 2,2′-bis(trifluoromethyl)benzidine (TFMB) and 3 mmol of 3,5-diaminobenzamide were added into the reaction vessel and dissolved in dimethylacetamide with stirring in nitrogen atmosphere. The amount of solvent was equivalent to 15% by weight of the total solid weight content. After it was completely dissolved, 2 mmol of CBDA and 3 mmol of 6FDA were added and stirred for 4 hours for dissolution and reaction, and the temperature of the solution was maintained at 15° C. Afterwards, 5 mmol of TPC was added and stirred for another 12 hours to continue the reaction. Then, 15 mmol of pyridine and 30 mmol of acetic anhydride were added and stirred for 30 minutes, followed by heating to 70° C. and stirring for 1 hour, and then cooling to room temperature. Finally, a large amount of methanol was used for precipitation, and then the precipitated solid was crushed by a pulverizer and dried into powder by vacuum drying.

### Comparative Example 4

10 mmol of 2,2′-bis(trifluoromethyl)benzidine (TFMB) was added into the reaction vessel and dissolved in dimethylacetamide with stirring in nitrogen atmosphere. The amount of solvent was equivalent to 15% by weight of the total solid weight content. After it was completely dissolved, 3 mmol of CBDA and 3 mmol of 6FDA were added and stirred for 4 hours for dissolution and reaction, and the temperature of the solution was maintained at 15° C. Afterwards, 4 mmol of TPC was added and stirred for another 12 hours to continue the reaction. Then, 15 mmol of pyridine and 30 mmol of acetic anhydride were added and stirred for 30 minutes, followed by heating to 70° C. and stirring for 1 hour, and then cooling to room temperature. Finally, a large amount of methanol was used for precipitation, and then the precipitated solid was crushed by a pulverizer and dried into powder by vacuum drying.

### Comparative Example 5

10 mmol of 2,2′-bis(trifluoromethyl)benzidine (TFMB) was added into the reaction vessel and dissolved in dimethylacetamide with stirring in nitrogen atmosphere. The amount of solvent was equivalent to 15% by weight of the total solid weight content. After it was completely dissolved, 2 mmol of CBDA and 2 mmol of 6FDA were added and stirred for 4 hours for dissolution and reaction, and the temperature of the solution was maintained at 15° C. Afterwards, 6 mmol of TPC was added and stirred for another 12 hours to continue the reaction. Then, 15 mmol of pyridine and 30 mmol of acetic anhydride were added and stirred for 30 minutes, followed by heating to 70° C. and stirring for 1 hour, and then cooling to room temperature. Finally, a large amount of methanol was used for precipitation, and then the precipitated solid was crushed by a pulverizer and dried into powder by vacuum drying.

### Comparative Example 6

9 mmol of 2,2′-bis(trifluoromethyl)benzidine (TFMB) and 1 mmol of 3,5-diaminobenzamide were added into the reaction vessel and dissolved in dimethylacetamide with stirring in nitrogen atmosphere. The amount of solvent was equivalent to 15% by weight of the total solid weight content. After it was completely dissolved, 3.5 mmol of CBDA and 3.5 mmol of 6FDA were added and stirred for 4 hours for dissolution and reaction, and the temperature of the solution was maintained at 15° C. Afterwards, 3 mmol of TPC was added and stirred for another 12 hours to continue the reaction. Then, 15 mmol of pyridine and 30 mmol of acetic anhydride were added and stirred for 30 minutes, followed by heating to 70° C. and stirring for 1 hour, and then cooling to room temperature. Finally, a large amount of methanol was used for precipitation, and then the precipitated solid was crushed by a pulverizer and dried into powder by vacuum drying.

### Comparative Example 7

9 mmol of 2,2′-bis(trifluoromethyl)benzidine (TFMB) and 1 mmol of 3,5-diaminobenzamide were added into the reaction vessel and dissolved in dimethylacetamide with stirring in nitrogen atmosphere. The amount of solvent was equivalent to 15% by weight of the total solid weight content. After it was completely dissolved, 1.5 mmol of CBDA and 1.5 mmol of 6FDA were added and stirred for 4 hours for dissolution and reaction, and the temperature of the solution was maintained at 15° C. Afterwards, 7 mmol of TPC was added and stirred for another 12 hours to continue the reaction. Then, 15 mmol of pyridine and 30 mmol of acetic anhydride were added and stirred for 30 minutes, followed by heating to 70° C. and stirring for 1 hour, and then cooling to room temperature. Finally, a large amount of methanol was used for precipitation, and then the precipitated solid was crushed by a pulverizer and dried into powder by vacuum drying.

The manufacturing method of polyamide-imide film is as what follows:

The polyamide-imide copolymer powder prepared in the above-mentioned Examples and Comparative Examples was dissolved in dimethyl acetamide and formulated to a concentration of 15% by weight. After the formulated solution was filtered with a filter, it was coated on a glass substrate by blade coating method, and then post-baked in a high temperature nitrogen atmosphere at 300° C. to form a polyamide-imide film with a fixed thickness of 25 μm.

The prepared polyamide-imide film was subjected to the following test.

<Total Transmittance (TT) and Haze>

The total light transmittance and haze of the polyamide-imide film were measured using Nippon Denshoku COH 5500 according to ASTM D1003.

<Yellowness Index YI>

The yellow index YI value of the polyamide-imide film was measured using Nippon Denshoku COH 5500 in accordance with ASTM E313. The yellow index YI was the tristimulus value (x, y, z) measured using the spectrophotometer for the transmittance of 400-700 nm light, and the YI was calculated by the following formula.

YI=100×(1.2769x−1.0592z)/y

<Thermal Expansion Coefficient> and <Glass Transition Temperature (Tg)>

The CTE value and glass transition temperature (Tg) from 50° C. to 200° C. were measured with the thermomechanical analyzer (TA Instrument TMA Q400EM). Before thermal analysis, all polyamide-imide films were heat-treated at 220° C. for 1 hour, and then the glass transition temperature was measured by TMA. In the film mode, the heating rate was 10° C./min and a constant load was applied at 30 mN. Similarly, the linear thermal expansion coefficient from 50 to 200° C. was measured using TMA, in which the load strain was 30 mN, and the heating rate was 10° C./min.

Calculation Method of Reduction Ratio of Thermal Expansion Coefficient

Under the same ratio of dianhydride monomer and aromatic dicarbonyl monomer, the reduction ratio of the thermal expansion coefficient of polyamide-imide film with and without addition of the diamine containing amide group is compared. The calculation formula is as what follows:

ΔCTE=(CTE0−CTE1)/CTE0

Wherein, CTE0 is the thermal expansion coefficient of the polyamide-imide film without adding the diamine containing amide group;

CTE1 is the thermal expansion coefficient of the polyamide imide film added with the diamine containing amide group.

<Tensile Strength>

The polyamide-imide film was cut into test pieces with a size of 10 mm×80 mm, and the tensile strength in the MD and TD directions was measured using the tensile testing machine (QC-505M2F produced by Cometech) at a tensile speed of 5 mm/min. The average value of the tensile strength in the MD and TD directions was calculated and recorded in Table 1.

<Elastic Modulus>

The polyamide-imide film was cut into test pieces with a size of 10 mm×80 mm, and the elastic modulus in the MD and TD directions was measured using the tensile testing machine (QC-505M2F produced by Cometech) at a tensile speed of 5 mm/min. The average value of the elastic modulus in the MD and TD directions was calculated and recorded in Table 1.

<Solvent Resistance Test>

The polyamide-imide film was cut into test pieces with a size of 50 mm×50 mm. The optical haze of the film was measured and recorded before soaking in the solvent, and then the test pieces were soaked in the organic solvent (PGMEA, toluene) for test at room temperature 25° C. for 10 minutes. After soaking, the haze of the test pieces was measured again, and the haze change before and after soaking was calculated.

Haze change less than 1%: ⊚

Haze change between 1-5%: ∘

Haze change greater than 5%: X

The test results are shown in Table 1.

TABLE 1

| | | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|
| Dianhydride | 6FDA | 3 | 3 | 3 | 3 | 3 | 3 | 3 | 3 | 2 |
| (mmol) | CBDA | 2 | | | 2 | 2 | 2 | 2 | 2 | 2 |
| | s-BPDA | | 2 | | | | | | | |
| | ODPA | | | 2 | | | | | | |
| Diamine | 3,5-DABAM | 1 | 1 | 1 | | 0.5 | 2 | 1 | 0.5 | 0.5 |
| (mmol) | 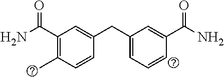 [SMILES: Cc1ccc(Cc2cccc(C(N)=O)c2)cc1C(N)=O] | | | | 1 | | | | | |
| | TFMB | 9 | 9 | 9 | 9 | 9.5 | 8 | 7 | 9.5 | 9.5 |
| | 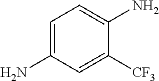 [SMILES: Nc1ccc(N)c(C(F)(F)F)c1] | | | | | | | 2 | | |
| aromatic | TPC | 5 | 5 | 5 | 5 | 5 | 5 | 5 | | 6 |
| dicarbonyl | IPC | | | | | | | | 5 | |
| (mmol) | | | | | | | | | | |
| percentage | % | 50 | 50 | 50 | 50 | 50 | 50 | 50 | 50 | 60 |
| of aromatic | | | | | | | | | | |
| dicarbonyl | | | | | | | | | | |
| Test items | Unit | | | | | | | | | |
| TT | % | 90.7 | 90.1 | 90.2 | 90.1 | 90.7 | 90.1 | 90.2 | 90.3 | 91.3 |
| Haze | % | 0.11 | 0.28 | 0.16 | 0.21 | 0.18 | 0.25 | 0.22 | 0.2 | 0.2 |
| YI | — | 1.8 | 2.7 | 2.3 | 1.8 | 1.68 | 1.9 | 1.9 | 1.8 | 1.7 |
| Tg | ° C. | 336 | 310 | 304 | 307 | 332 | 337 | 321 | 302 | 320 |
| CTE | ppm/° C. | 8.8 | 4.8 | 21 | 10.1 | 11.2 | 1.5 | 8.2 | 11.6 | 8.4 |
| reduction | % | 51.9 | — | — | 44.8 | 38.8 | 91.8 | 55.2 | 36.6 | 35.8 |
| ratio | | | | | | | | | | |
| of CTE | | | | | | | | | | |
| Tensile | MPa | 184 | 177 | 171 | 170 | 182 | 171 | 179 | 171 | 172 |
| Strength | | | | | | | | | | |
| Elastic | GPa | 6.1 | 6.3 | 5.7 | 5.9 | 6.0 | 6.1 | 6.1 | 5.7 | 6.6 |
| Modulus | | | | | | | | | | |
| Chemical | PGMEA | ⊚ | ⊚ | ⊚ | ⊚ | ◯ | ⊚ | ⊚ | ⊚ | ⊚ |
| resistance | | | | | | | | | | |
| | Toluene | ⊚ | ⊚ | ⊚ | ⊚ | ◯ | ⊚ | ⊚ | ⊚ | ⊚ |

| | | | | | | | |
|---|---|---|---|---|---|---|---|
| Ex. | Comp. | Comp. | Comp. | Comp. | Comp. | Comp. | Comp. |
| 10 | Ex. 1 | Ex. 2 | Ex. 3 | Ex. 4 | Ex. 5 | Ex. 6 | Ex. 7 |

| | | | | | | | | | |
|---|---|---|---|---|---|---|---|---|---|
| Dianhydride | 6FDA | 3 | 3 | 3 | 3 | 3 | 2 | 3.5 | 1.5 |
| (mmol) | CBDA | 2 | 2 | 2 | 2 | 3 | 2 | 3.5 | 1.5 |
| | s-BPDA | | | | | | | | |
| | ODPA | | | | | | | | |
| Diamine | 3,5-DABAM | 0.5 | 0 | 0.1 | 3 | 0 | 0 | 1 | 1 |
| (mmol) | 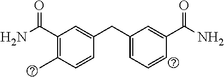 [SMILES: Cc1ccc(Cc2cccc(C(N)=O)c2)cc1C(N)=O] | | | | | | | | |
| | TFMB | 9.5 | 10 | 9.9 | 7 | 10 | 10 | 9 | 9 |
| | 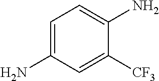 [SMILES: Nc1ccc(N)c(C(F)(F)F)c1] | | | | | | | | |
| aromatic | TPC | 4 | 5 | 5 | 5 | 4 | 6 | 3 | 7 |
| dicarbonyl | IPC | | | | | | | | |
| (mmol) | | | | | | | | | |
| percentage | % | 40 | 50 | 50 | 50 | 40 | 60 | 30 | 70 |
| of aromatic | | | | | | | | | |
| dicarbonyl | | | | | | | | | |
| Test items | Unit | | | | | | | | |
| TT | % | 91.2 | 91 | 90.9 | 88.7 | 91.2 | 90.7 | 91.2 | 88.1 |
| Haze | % | 0.16 | 0.21 | 0.18 | 0.25 | 0.22 | 0.3 | 0.22 | 12 |
| YI | — | 1.57 | 1.32 | 1.5 | 3.5 | 1.4 | 1.35 | 1.42 | 2 |
| Tg | ° C. | 312 | 310 | 310 | 340 | 307 | 310 | 294 | 319 |
| CTE | ppm/° C. | 16.2 | 18.3 | 18.1 | 0.2 | 43.6 | 13.1 | 35 | 11 |
| reduction | % | 62.8 | — | 1.1 | 98.9 | — | — | — | — |
| ratio of | | | | | | | | | |
| CTE | | 178 | | | | | | | |
| Tensile | MPa | 5.5 | 179 | 181 | 171 | 185 | 190 | 152 | 141 |
| Strength | | | | | | | | | |
| Elastic | GPa | | 6.2 | 6.2 | 5.7 | 5.1 | 7.1 | 4.5 | 6.2 |
| Modulus | | ⊚ | | | | | | | |
| Chemical | PGMEA | | X | X | ⊚ | X | X | ⊚ | ⊚ |
| resistance | Toluene | ⊚ | X | X | ⊚ | X | ◯ | ⊚ | ⊚ |

<Note>
The percentage of aromatic dicarbonyl refers to the percentage of the molar number of aromatic dicarbonyl monomer to the total molar number of the dianhydride monomer and the aromatic dicarbonyl monomer.

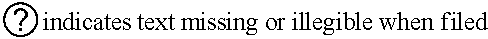

Comparing Examples 1, 5, and 6 with Comparative Examples 1, 2, and 3, as the addition amount of the diamine containing amide functional group increases, the degree of chemical resistance increases, and the thermal expansion coefficient also decreases accordingly. When the diamine containing amide group is added less than 5%, its chemical resistance and thermal expansion coefficient are similar to the results of the unadded control group. When the diamine containing amide group is added more than 20%, the total optical transmittance and YI value of the film would be affected and are 88.7% and 3.5 respectively. In addition, it can be seen from the results that when the diamine containing amido group is added more than 5%, the reduction ratio can be greater than 30% compared to the diamine without amido group (Comparative Example 1).

The results of Examples 5, 9, 10 and Comparative Examples 5 and 6 show that when the ratio of amide groups falls within 40-60%, the elastic modulus can be maintained above 5 GPa; when the ratio of amide groups is less than 40%, the elastic modulus is less than 5 GPa; and when the proportion of amide is greater than 60%, although the elastic modulus can still be greater than 5 GPa, the film is prone to crystallization as the structure of amide increases, which causes the haze to increase to more than 10%, resulting in restrictions on its application.

In summary, the present invention is a copolymer copolymerized using specific monomers at a specific ratio. The film made from the copolymer has excellent transparency, heat resistance (for example, high glass transition temperature and low thermal expansion coefficient) and elastic modulus.

However, the above are only preferred embodiments of the present invention, and should not be used to limit the scope of implementation of the present invention. Therefore, all the simple and equivalent changes and modifications made according to the claims and the specification of the present application are still within the scope of the present invention.

What is claimed is:

1. A polyamide-imide copolymer obtained by copolymerizing an aromatic diamine monomer, a dianhydride monomer and an aromatic dicarbonyl monomer,
wherein a molar number of the aromatic dicarbonyl monomer accounts for 40%-60% of a total molar number of the dianhydride monomer and the aromatic dicarbonyl monomer; and
the aromatic diamine monomer comprises a diamine containing an amide group (—CONH₂), the diamine containing the amide group is represented by formula (1) below, and the diamine containing the amide group (—CONH₂) accounts for 5-20% of a total molar number of the aromatic diamine monomer: 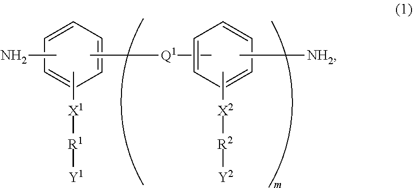
wherein m is an integer from 0 to 5; Q¹ is the same or different each time it appears and each independently —CH₂—, —C₂H₄—, —C₂H₂—, —C₃H₆—, —C₃H₄—, —C₄H₈— —C₄H₆—, —C₄H₄—, —C(CF₃)₂—, —O—, —CONH—, —NHCO—, —COO—, —OCO—, —NH—, —CO—, —SO₂—, —SO₂NH— or —NHSO₂—; X¹ and X² are the same or different, X² is the same or different each time it appears, X¹ and X² are each independently a single bond, —CONH—, —NHCO—, —CONHCH₂—, —CH₂CONH—, —CH₂NHCO—, —NHCOCH₂—, —COO—, —OCO—, —COOCH₂—, —CH₂COO—, —CH₂OCO—, —OCOCH₂—, —CO—, —CH₂CO—, —COCH₂—, —CH₂SO₂NH—, —SO₂NHCH₂—, —NHSO₂CH₂— or —CH₂NHSO₂—; R¹ and R² are the same or different, R² is the same or different each time it appears, R¹ and R² are each independently a single bond, C₁-C₃₀ alkylene, C₁-C₃₀ divalent carbocyclic or C₁-C₃₀ divalent heterocyclic ring, the alkylene, the divalent carbocyclic and the divalent heterocyclic ring may be substituted by one or more fluorine or organic groups; Y¹ and Y² are the same or different, Y² is the same or different each time it appears, Y¹ and Y² are each independently a hydrogen atom or —CONH₂, provided that at least one of Y¹ and Y² is —CONH₂.

2. The copolymer of claim 1, wherein the aromatic diamine monomer further comprises 2-(trifluoromethyl)-1,4-phenylenediamine, bis(trifluoromethyl)benzidine (TFDB), 4,4′-oxydianiline (ODA), para-Methylene Dianiline (pMDA), meta-Methylene Dianiline (mMDA), 1,3-bis(3-aminophenoxy)benzene (133APB), 1,3-bis(4-aminophenoxy)benzene (134APB), 2,2′-bis[4(4-aminophenoxy)phenyl]hexafluoropropane (4BDAF), 2,2′-bis(3-aminophenyl)hexafluoropropane (33-6F), (2,2′-bis(4-aminophenyl)hexafluoropropane (44-6F), bis(4-aminophenyl)sulfone (4DDS), bis(3-aminophenyl)sulfone (3DDS), 2,2-Bis[4-(4-aminophenoxy)-phenyl]propane (6HMDA), 2,2-Bis(3-amino-4-hydroxy-phenyl)-hexafluoropropane (DBOH), 4,4′-Bis(3-amino phenoxy)diphenyl sulfone (DBSDA), 9,9-Bis(4-aminophenyl)fluorene (FDA), 9,9-Bis(3-fluoro-4-aminophenyl)fluorene (FFDA), polyetheramine or a combination thereof.

3. The copolymer of claim 1, wherein the diamine containing the amide group comprises 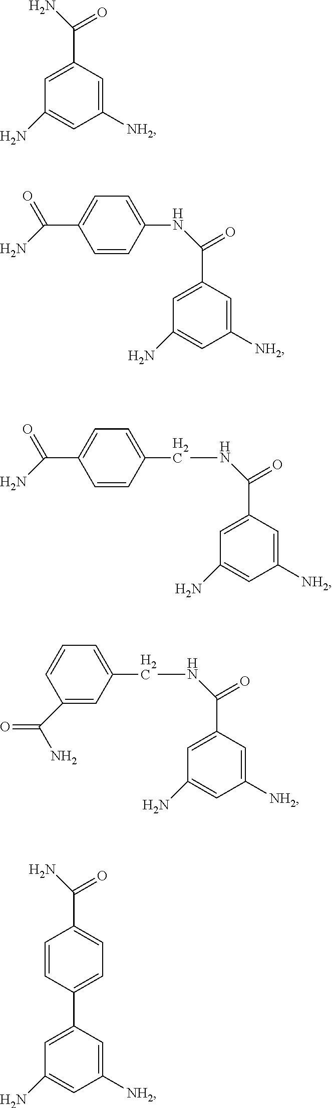 [SMILES: NC(=O)c1cc(N)cc(N)c1 ; NC(=O)c1ccc(NC(=O)c2cc(N)cc(N)c2)cc1 ; NC(=O)c1ccc(CNC(=O)c2cc(N)cc(N)c2)cc1 ; NC(=O)c1cccc(CNC(=O)c2cc(N)cc(N)c2)c1 ; NC(=O)c1ccc(-c2cc(N)cc(N)c2)cc1] 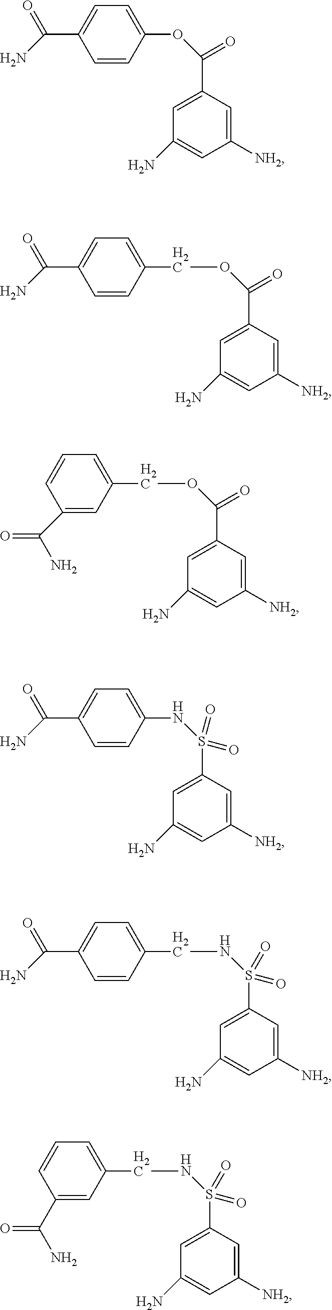 [SMILES: NC(=O)c1ccc(OC(=O)c2cc(N)cc(N)c2)cc1 ; NC(=O)c1ccc(COC(=O)c2cc(N)cc(N)c2)cc1 ; NC(=O)c1cccc(COC(=O)c2cc(N)cc(N)c2)c1 ; NC(=O)c1ccc(NS(=O)(=O)c2cc(N)cc(N)c2)cc1 ; NC(=O)c1ccc(CNS(=O)(=O)c2cc(N)cc(N)c2)cc1 ; NC(=O)c1cccc(CNS(=O)(=O)c2cc(N)cc(N)c2)c1] 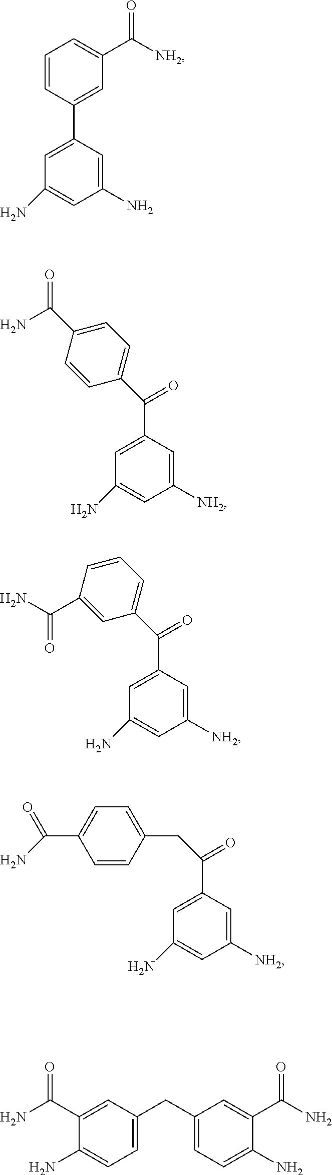 [SMILES: NC(=O)c1cccc(-c2cc(N)cc(N)c2)c1 ; NC(=O)c1ccc(C(=O)c2cc(N)cc(N)c2)cc1 ; NC(=O)c1cccc(C(=O)c2cc(N)cc(N)c2)c1 ; NC(=O)c1ccc(CC(=O)c2cc(N)cc(N)c2)cc1 ; NC(=O)c1cc(Cc2ccc(N)c(C(N)=O)c2)ccc1N]
or a combination thereof.

4. The copolymer of claim 1, wherein the dianhydride monomer comprises an aromatic dianhydride, an aliphatic dianhydride or a combination thereof.

5. The copolymer of claim 4, wherein the aromatic dianhydride comprises 4,4′-(4,4′-isopropyldienediphenoxy)bis(phthalic anhydride), 4,4′-(hexafluoroisopropylene)diphthalic anhydride, 3,3′,4,4′-benzophenonetetracarboxylic dianhydride, 3,3′,4,4′-biphenyl tetracarboxylic dianhydride, 2,3,3′,4′-biphenyl tetracarboxylic dianhydride, 4,4′-oxydiphthalic anhydride, 3,3′,4,4′-diphenylsulfonetetracarboxylic dianhydride, biscarboxyphenyl dimethyl silane dianhydride, bis-dicarboxyphenoxydiphenyl sulfide dianhydride, sulfonyl diphthalic anhydride or a combination thereof.

6. The copolymer of claim 4, wherein the aliphatic dianhydride comprises 1,2,3,4-cyclobutanetetracarboxylic dianhydride, cyclohexane-1,2,4,5-tetracarboxylic dianhydride, 1,1′-bi(cyclohexyl)-3,3′,4,4′-tetracarboxylic dianhydride, 1,1′-bi(cyclohexane)-2,3,3′,4′-tetracarboxylic dianhydride, 1,1′-bi(cyclohexane)-2,2′,3,3′-tetracarboxylic dianhydride, 4,4′-methylene bis(cyclohexane-1,2-dicarboxylic anhydride), 4,4′-(propane-2,2-diyl)bis(cyclohexane-1,2-dicarboxylic anhydride), 4,4′-oxybis(cyclohexane-1,2-dicarboxylic anhydride), 4,4′-thiobis(cyclohexane-1,2-dicarboxylic anhydride), 4,4′-sulfonyl bis(cyclohexane-1,2-dicarboxylic anhydride), 4,4′-(dimethylsilanediyl) bis(cyclohexane-1,2-dicarboxylic anhydride), 4,4′-(tetrafluoropropane-2,2-diyl) bis(cyclohexane-1,2-dicarboxylic anhydride), octahydro-pentalene-1,3,4,6-tetracarboxylic dianhydride, bicyclo[2.2.1]heptane-2,3,5,6-tetracarboxylic dianhydride, (8aS)-hexahydro-3H-4,9-Methylfuran[3,4-g]isopentene-1,3,5,7(3aH)-tetraketone, bicyclo[2.2.2]octane-2,3,5,6-tetracarboxylic dianhydride, bicyclo[2.2.2]oct-5-ene-2,3,7,8-tetracarboxylic dianhydride, tricyclo[4.2.2.02,5]decane-3,4,7,8-tetracarboxylic dianhydride, tricyclo[4.2.2.02,5]dec-7-ene-3,4,9,10-tetracarboxylic dianhydride, 9-oxatricyclo[4.2.1.02,5]nonane-3,4,7,8-tetracarboxylic dianhydride, norbornane-2-spiro-α-cyclopentanone-α′spiro-2′-norbornane-5,5′,6,6′-tetracarboxylic dianhydride, (4arH,8acH)-decahydro-1t,4t:5c,8c-dimethanonaphthalene-2c,3c,6c,7c-tetracarboxylic dianhydride, (4arH,8acH)-decahydro-1t,4t:5c,8c-dimethanonaphthalene-2t,3t,6c,7c-tetracarboxylic dianhydride or a combination thereof.

7. The copolymer of claim 1, wherein the aromatic dicarbonyl monomer includes 4,4′-biphenyldicarbonyl chloride (BPC), isophthaloyl chloride (IPC), terephthaloyl chloride (TPC) or a combination thereof.

8. The copolymer of claim 1, wherein the aromatic diamine monomer excludes an aromatic diamine substituted with a nitrile group.

9. A film comprising the copolymer of claim 1.

10. The film of claim 9, having an elastic modulus of greater than 5 GPa.
